(19) United States
(12) Patent Application Publication
(10) Pub. No.: US 2023/0162673 A1
(43) Pub. Date: May 25, 2023

(54) PIXEL CIRCUIT AND ITS DRIVING METHOD, DISPLAY PANEL AND DISPLAY DEVICE

(71) Applicant: Shenzhen China Star Optoelectronics Semiconductor Display Technology Co., Ltd., Shenzhen, Guangdong (CN)

(72) Inventors: Guohui LIU, Shenzhen, Guangdong (CN); Zhenling WANG, Shenzhen, Guangdong (CN)

(73) Assignee: Shenzhen China Star Optoelectronics Semiconductor Display Technology Co., Ltd., Shenzhen, Guangdong (CN)

(21) Appl. No.: 17/429,399

(22) PCT Filed: Jun. 23, 2021
(86) PCT No.: PCT/CN2021/101753

§ 371 Date: Aug. 9, 2021

(30) Foreign Application Priority Data
Feb. 5, 2021 (CN) 202110160796.7

(51) Int. Cl. G09G 3/3233; G09G 3/32

(52) U.S. Cl. CPC G09G 3/3233; G09G 3/32; G09G 2300/0819; G09G 2300/0842; G09G 2310/08; G09G 2330/021; G09G 2320/0233; G09G 2310/0256

(57) ABSTRACT

A pixel circuit is provided. The pixel circuit includes a light emitting module and a drive module. A first terminal of the drive module is electrically connected with the light emitting module. A first control terminal of the drive module loads a first signal in a first period. The first control terminal of the drive module loads a second signal in a second period. The first signal and the second signal have opposite polarity. There is no intersection between the first period and the second period. A driving method of the pixel circuit, a display panel and a display device are also provided.

### TECHNICAL FIELD

The present disclosure relates to a field of display technology, particularly to a pixel circuit, a driving method of the pixel circuit, a display panel and a display device.

### BACKGROUND

Organic light emitting diode (OLED) display devices are widely used by its advantages of light weight, thin thickness, bendable, and large viewing angle range.

In a conventional OLED display, a thin film transistor is used in its pixel circuit to control a current passing through the OLED to control the light emitting condition of the OLED. When the thin film transistor is working, a gate electrode of the thin film transistor is loaded as a positive signal by a unique and fixed signal source, which causes a difference between a gate signal and a source signal of the thin film transistor to remain a positive signal for a long time. This situation leads to a single change in a threshold voltage drift of the thin film transistor, accelerates a drift of the threshold voltage of the thin film transistor, seriously affects uniformity of the display panel, and reduces life of the display panel.

Therefore, it is necessary to provide a pixel circuit and its driving method, a display panel, and a display device which can reduce the drift of the threshold voltage of the thin film transistor for driving the OLED to emit light.

### SUMMARY

The present disclosure provides a thin film transistor device, a backlight module and a display panel, which can solve the problem that a driving current of a Mini LED in the prior art is small, which causes the backlight intensity of the Mini LED backplane to be low.

The present disclosure provides a pixel circuit and a driving method of the pixel circuit, a display panel and a display device, which can solve a threshold voltage drifting along a single direction problem of a conventional drive module, which affects an uniformity of the display panel.

The embodiments of the present disclosure provide a pixel circuit, the pixel circuit includes:

A light emitting module.

A drive module, a first terminal of the drive module is electrically connected with the light emitting module, a first control terminal of the drive module is configured to load a first signal in a first period, and the first control terminal of the drive module is configured to load a second signal in a second period, the first signal and the second signal have opposite polarity, and there is no intersection between the first period and the second period.

In one embodiment, the pixel circuit further includes:

A first signal module, the first signal module is electrically connected with the first control terminal of the drive module, and the first control terminal of the drive module is loaded with a first signal by the first signal module in the first period, and a polarity of the first signal is negative.

A second signal module, the second signal module is electrically connected with the first control terminal of the drive module, and the first control terminal of the drive module is loaded with a second signal by the second signal module in the second period, and a polarity of the second signal is positive.

In one embodiment, the first signal module includes a first signal source and a first switch, the first switch is turned on in the first period for driving the first signal source to load the first signal to the first control terminal of the drive module.

In one embodiment, the second signal module includes a second signal source and a second switch, the second switch is turned on in the second period for driving the second signal source to load the second signal to the first control terminal of the drive module.

In one embodiment, the drive module includes:

A driving thin film transistor which is a double gate thin film transistor, a top gate electrode of the driving thin film transistor is set as the first control terminal of the drive module, and a bottom gate electrode of the driving thin film transistor is set as a second control terminal of the drive module.

In one embodiment, when the driving thin film transistor is an N-type thin film transistor, a threshold voltage of the driving thin film transistor is positively correlated with the top gate electrode of the driving thin film transistor, and the threshold voltage of the driving thin film transistor is negatively correlated with the bottom gate electrode of the driving thin film transistor.

In one embodiment, the pixel circuit further includes:

A compensation module configured to adjust a threshold voltage of the drive module, a first terminal of the compensation module is electrically connected with the second control terminal of the drive module, and a second terminal of the compensation module is electrically connected with the first terminal of the drive module.

In one embodiment, the compensation module includes:

A compensation capacitor configured to store a signal of the second control terminal of the drive module, a first terminal of the compensation capacitor is electrically connected with the second control terminal of the drive module, and a second terminal of the compensation capacitor is connected with a ground terminal.

A compensating thin film transistor, a gate electrode of the compensating thin film transistor is electrically connected with the second signal module, a source electrode of the compensating thin film transistor is electrically connected with the first terminal of the drive module, a drain electrode of the compensating thin film transistor is electrically connected with the second control terminal of the drive module, and the drain electrode of the compensating thin film transistor is configured to adjust the threshold voltage of the drive module

In one embodiment, the pixel circuit further includes:

A data signal module.

A write module, an input terminal of the write module is electrically connected with the data signal module.

A memory module, a first terminal of the memory module is electrically connected with an output terminal of the memory module and the first control terminal of the drive module, and a second terminal of the memory module is electrically connected with the second terminal of the drive module.

In one embodiment, the write module includes a write switch, a first terminal of the write switch is set as the input terminal of the write module, a second terminal of the write switch is set as the output terminal of the write module, and a control terminal of the write switch is electrically connected with a scanning voltage module configured to control whether the write switch is turned on.

The memory module includes a storage capacitor configured to store a data signal, a first terminal of the storage capacitor is set as the first terminal of the memory module, and a second terminal of the storage capacitor is set as the second terminal of the memory module.

In one embodiment, the pixel circuit further includes:

A pre-storage module configured to store the data signal provided by the data signal module, an input terminal of the pre-storage module is electrically connected with the output terminal of the write module, and an output terminal of the pre-storage module is electrically connected with the first terminal of the memory module.

In one embodiment, the pre-storage module includes:

A pre-storage capacitor configured to store the data signal, a first terminal of the pre-storage capacitor is set as the input terminal of the pre-storage module, and a second terminal of the pre-storage capacitor is connected with the ground terminal.

A compensating thin film transistor, a gate electrode of the compensating thin film transistor is electrically connected with the second signal module, a source electrode of the compensating thin film transistor is electrically connected with the first terminal of the drive module, a drain electrode of the compensating thin film transistor is electrically connected with the second control terminal of the drive module, and the drain electrode of the compensating thin film transistor is configured to adjust the threshold voltage of the drive module.

In one embodiment, the light emitting module includes a micro light emitting diode.

In one embodiment, the pixel circuit further includes:

A power module, a power supply terminal of the light emitting module is electrically connected with the power module, and a working terminal of the light emitting module is electrically connected with the first terminal of the drive module, when an operating voltage is inputted to the light emitting module by the power module, a light emitting condition of the light emitting module is controlled by the driving module.

The embodiments of the present disclosure provide a display panel, the display panel includes the pixel circuit as described above.

The embodiments of the present disclosure provide a display device, the display includes the display panel as described above.

The embodiments of the present disclosure provide a driving method, the driving method is applied to a pixel circuit, and the driving method includes:

Loading a second signal to a first control terminal of a drive module in a second period.

Driving a drive module to control a light emitting module to emit light.

Loading a first signal to the first control terminal of the drive module in a first period.

In one embodiment, the pixel circuit further includes a power module, a transformer module, a memory module, a first signal module, a second signal module, a compensation module, a pre-storage module and a write module, the light emitting module includes a OLED device, the drive module includes a driving thin film transistor, the memory module includes a storage capacitor, the first signal module includes a first signal source and a first switch, the second signal module includes a second signal source and a second switch, the compensation module includes a compensating thin film transistor, the pre-storage module includes a pre-storage switch, the write module includes a write switch, and the driving method further includes:

In an initialization phase, controlling the power module to input a low voltage to an anode terminal of the OLED device, controlling the transformer module to input a high voltage to a source electrode of the driving thin film transistor and a second terminal of the storage capacitor, controlling the second signal control module to input a high voltage to a gate electrode of the second switch and a gate electrode of the compensating thin film transistor, and controlling the second signal source to output a high voltage.

In a compensation phase, maintaining the power module to input the low voltage to the anode terminal of the OLED device, controlling the transformer module to input a low voltage to the source electrode of the driving thin film transistor and the second terminal of the storage capacitor, controlling a second control module to input the high voltage to the gate electrode of the second switch and the gate electrode of the compensating thin film transistor, and controlling the second signal source to output a low voltage.

In a write phase, controlling a pre-storage voltage module to input the high voltage to the pre-storage switch.

In a light emitting phase, controlling the power module to input the high voltage to the anode terminal of the OLED device, controlling the pre-storage voltage module to input a low voltage to the pre-storage switch, controlling a scan voltage module input a high voltage to a control terminal of the write switch.

In a reversal phase, controlling the first control module to input a high voltage to a gate electrode of the first switch, and controlling the first signal source to output a low voltage.

The present disclosure provides a pixel circuit and its driving method, a display panel, and a display device. The pixel circuit includes a light emitting module and a drive module. A first terminal of the drive module is electrically connected with the light emitting module. A first control terminal of the drive module is configured to load a first signal in a first period, and the first control terminal of the drive module is configured to load a second signal in a second period, the first signal and the second signal have opposite polarity, and there is no intersection between the first period and the second period. It is realized that the first control terminal of the drive module is alternately loaded as the first signal and the second signal with opposite polarity in the first period and the second period. Therefore, in the present disclosure, the first control terminal of the drive module is alternately set to two signals with opposite polarity, so as to slow down the deviation of the threshold voltage of the drive module and stabilize the driving current of the light-emitting module, and to improve the display uniformity of the display panel and reduce the life of the display panel.

### DESCRIPTION OF DRAWINGS

The embodiments of the present disclosure will be described hereinafter with reference to the accompanying drawings, the technical solutions and the beneficial effects of the present disclosure will be obviously.

FIG. 1 is a structural block diagram of a pixel circuit provided by an embodiment of the present disclosure.

FIG. 2 is a circuit diagram of the pixel circuit provided by an embodiment of the present disclosure.

FIG. 3 is a schematic diagram of a connection between a driving thin film transistor and a compensating thin film transistor provided by an embodiment of the present disclosure.

FIG. 4 is a graph of a voltage difference between a gate electrode and a source electrode of a driving thin film transistor as a function of time provided by an embodiment of the present disclosure.

FIG. 5 is another graph of the voltage difference between the gate electrode and the source electrode of the driving thin film transistor as the function of time provided by an embodiment of the present disclosure.

FIG. 6 is a structural diagram of a driving thin film transistor provided by an embodiment of the present disclosure.

FIG. 7 is a graph showing the variation of Vth versus Vbs of two types of N-type vertical double-gate transistors provided by an embodiments of the present disclosure.

FIG. 8 is a flowchart of a driving method provided by an embodiment of this present disclosure.

FIG. 9 is a timing diagram of the driving method provided by an embodiment of the present disclosure.

FIG. 10 is a flowchart of another driving method provided by an embodiment of the present disclosure.

### DETAILED DESCRIPTION OF PREFERRED EMBODIMENTS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

The terms “first” and “second” in the present disclosure are used to distinguish between different objects and are not used to describe a particular order. In addition, the terms “includes” and “has” and any variations of them are intended to cover non-exclusive inclusion. For example, a process, method, system, product, or device that includes a series of steps or modules is not limited to the listed steps or modules, but optionally also includes steps or modules that are not listed, or optionally also includes other steps or modules that are inherent to these processes, methods, products, or devices.

References herein to “embodiments” mean that particular features, structures, or characteristics described in connection with an embodiment may be included in at least one embodiment of the present disclosure. The appearance of the phrase in various places in the specification does not necessarily mean the same embodiment, nor is it a separate or alternative embodiment namely mutually exclusive with other embodiments. It is understood, both explicitly and implicitly, by those skilled in the art that the embodiments described herein may be combined with other embodiments.

The embodiments of the present disclosure provide a pixel circuit, and the pixel circuit includes but is not limited to the following embodiments and a combination of the following embodiments.

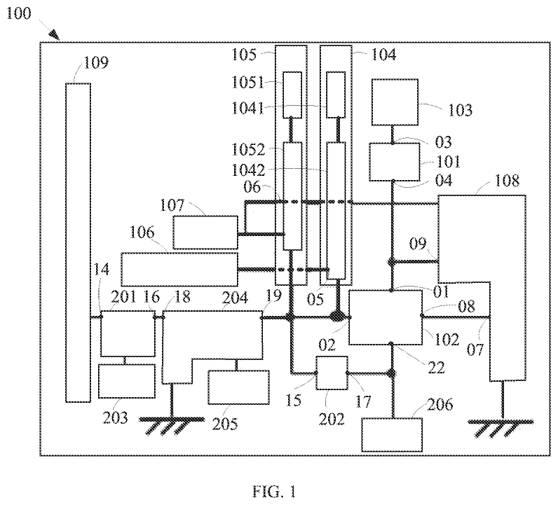

In one embodiment of the present disclosure, referring to FIG. 1, the pixel circuit 100 includes a light emitting module 101 and a drive module 102, a first terminal 01 of the drive module 102 is electrically connected with the light emitting module 101. A first control terminal 02 of the drive module 102 is configured to load a first signal in a first period, and the first control terminal 02 of the drive module 102 is configured to load a second signal in a second period, the first signal and the second signal have opposite polarity, and there is no intersection between the first period and the second period.

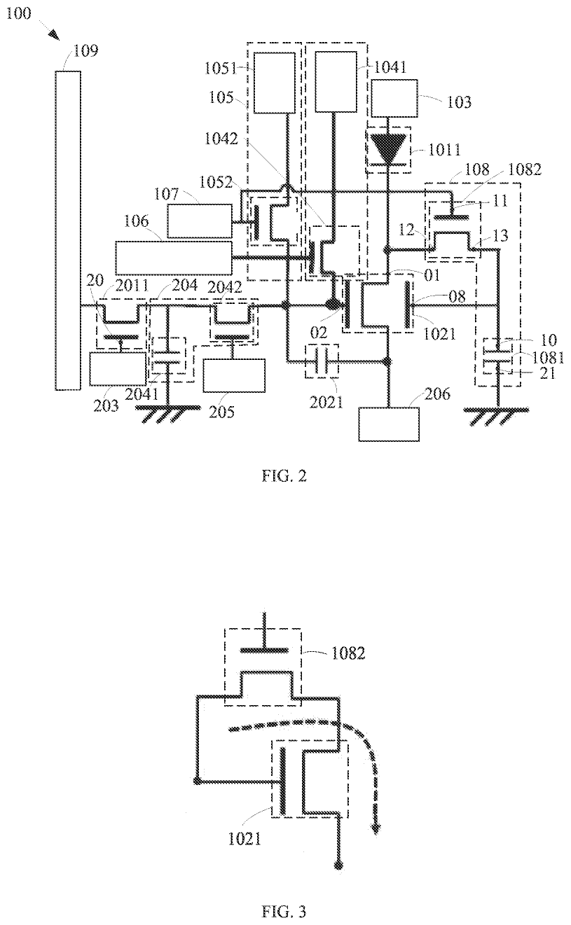

Referring to FIG. 1, the pixel circuit 100 further includes a power module 103, a power supply terminal 03 of the light emitting module 101 is electrically connected with the power module 103, and a working terminal 04 of the light emitting module 101 is electrically connected with the first terminal 01 of the drive module 102. When an operating voltage output by the power module 103 is constant, the drive module 102 can control the light emitting condition of the light emitting module 101. Specifically, referring to FIG. 2, the light emitting module 101 includes a micro light emitting diode 1011. An anode terminal of the micro light emitting diode 1011 is set as the power supply terminal 03 of the light emitting module 101, and a cathode terminal of the micro light emitting diode 1011 is set as the working terminal 04 of the light emitting module 101. A signal output by the power module 103 may be a constant high voltage signal, and the signal output by the power module 103 provides a working circuit for the micro light emitting diode 1011.

In one embodiment of the present disclosure, referring to FIG. 1, the pixel circuit 100 further includes a first signal module 104 and a second signal module 105. The first signal module 104 is electrically connected with the first control terminal 02 of the drive module 102, and the first control terminal 02 of the drive module 102 is loaded with a first signal by the first signal module 104 in the first period, and a polarity of the first signal is negative. The second signal module 105 is electrically connected with the first control terminal 02 of the drive module 102, and the first control terminal 02 of the drive module 102 is loaded with a second signal by the second signal module 105 in the second period, and a polarity of the second signal is positive.

Since the first control terminal 02 of the drive module 102 is loaded with a first signal by the first signal with a negative polarity module 104 in the first period, the first control terminal 02 of the drive module 102 is loaded with a second signal with a positive polarity by the second signal module 105 in the second period, and one cycle of working time of the drive module 102 may include the first period and the second period, the first control terminal 02 of the drive module 102 can be alternately loaded with two voltages with different polarities during the working time of the drive module 102, and the deviation of the threshold voltage of the drive module 102 can be slowed down to stabilize the driving current of the light emitting module 101, so as to improve the display uniformity of the display panel and reduce the lifespan of the display panel.

In one embodiment of the present disclosure, referring to FIG. 2, the first signal module 104 includes a first signal source 1041 and a first switch 1042, the first switch 1042 is turned on in the first period for driving the first signal source 1041 to load the first signal to the first control terminal 02 of the drive module 102. Specifically, a control terminal 05 of the first switch 1042 is electrically connected with a first control signal module 106. The first control signal module 106 can output a periodic first pulse signal, and a pulse width of the first pulse signal is equal to the first time period. The first signal source 1041 outputs a first signal, and the first signal may specifically be a constant voltage signal with a negative polarity. When the control terminal 05 of the first switch 1042 is loaded with a first pulse signal, and the first pulse signal is in the high voltage period of the first pulse signal, the first switch 1042 is turned on, and the first signal is loaded on the first control terminal 02 of the drive module 102 through the first switch 1042.

In one embodiment of the present disclosure, referring to FIG. 2, the second signal module 105 includes a second signal source 1051 and a second switch 1052, the second switch 1052 is turned on in the second period for driving the second signal source 1051 to load the second signal to the first control terminal 02 of the drive module 102. Specifically, a control terminal 06 of the second switch 1052 is electrically connected with a second control signal module 107. The second control signal module 107 can output a periodic second pulse signal, and a pulse width of the second pulse signal is equal to the second time period. The second signal source 1051 outputs a second signal, and the second signal may specifically be a constant voltage signal with a positive polarity. When the control terminal 06 of the second switch 1052 is loaded with a signal, and the signal is in the high voltage period of the second pulse signal, the second switch 1052 is turned on, and the second signal is loaded on the first control terminal 02 of the drive module 102 through the second switch 1052.

In one embodiment of the present disclosure, referring to FIG. 2, the drive module 102 includes a driving thin film transistor 1021 which is a double gate thin film transistor, a top gate electrode of the driving thin film transistor 1021 is set as the first control terminal 02 of the drive module 102, and a bottom gate electrode of the driving thin film transistor 1021 is set as a second control terminal 08 of the drive module 102. Specifically, the driving thin film transistor 1021 may further include a source electrode and drain electrode layer. The source electrode and drain electrode layer includes a source electrode and a drain electrode arranged in the same layer. The top gate electrode, the source drain electrode layer and the bottom gate electrode are stacked. The threshold voltage of the driving thin film transistor 1021 is the threshold voltage of the drive module 102. There is a voltage difference between the top gate electrode and the source electrode of the driving thin film transistor 1021, and the difference between the voltage difference and the threshold voltage of the driving thin film transistor 1021 is used to control the conduction state of the driving thin film transistor 1021.

When the driving thin film transistor is an N-type thin film transistor, a threshold voltage of the driving thin film transistor is positively correlated with the top gate electrode of the driving thin film transistor, and the threshold voltage of the driving thin film transistor is negatively correlated with the bottom gate electrode of the driving thin film transistor. The method of adjusting the threshold voltage of the driving thin film transistor 1021 includes, but is not limited to, adjusting the bottom gate electrode of the driving thin film transistor 1021 to adjust the threshold voltage of the driving thin film transistor 1021. Specifically, the voltage of the bottom gate electrode of the driving thin film transistor 1021 changes as the voltage of the drain electrode of the driving thin film transistor 1021 changes.

In one embodiment of the present disclosure, referring to FIG. 1, the pixel circuit 100 further includes a compensation module 108, a first terminal 07 of the compensation module 108 is electrically connected with the second control terminal 08 of the drive module 102, and a second terminal 09 of the compensation module 108 is electrically connected with the first terminal 01 of the drive module 102, the compensation module 108 is configured to adjust a threshold voltage of the drive module 102. Specifically, the first terminal 07 of the compensation module 108 can adjust the second control terminal 08 of the drive module 102 by controlling the voltage of the second control terminal 08 of the drive module 102, so that the threshold voltage of the drive module 102 is within a preset voltage range. The threshold voltage of the drive module 102 makes the drive module 102 in a critical conduction state.

It can be understood that when the threshold voltage of the drive module 102 drifts, the light emitting condition of the light emitting module 101 will be affected. In this embodiment, the drive module 102 further includes a second control terminal 08. In addition, the second control terminal 08 of the drive module 102 is electrically connected with the compensation module 108 to control the second control terminal 08 of the drive module 102. The drive module 102 has the property that “the threshold voltage of the drive module 102 is negatively correlated or positively correlated with the voltage of the second control terminal 08 of the drive module 102”. Therefore, the embodiment of the present disclosure can reasonably control the signal of the second control terminal 08 according to the actual situation, so that the threshold voltage of the drive module 102 is within the preset voltage range, namely, the threshold of the drive module 102 is increased. The stability of the voltage improves the accuracy of the light emission of the light-emitting module 101.

In one embodiment of the present disclosure, referring to FIG. 2, the compensation module 108 includes a compensation capacitor 1081 and a compensating thin film transistor 1082. A first terminal 10 of the compensation capacitor 1081 is electrically connected with the second control terminal 08 of the drive module 102, and a second terminal 21 of the compensation capacitor 1081 is connected with a ground terminal, the compensation capacitor 1081 is configured to store a signal of the second control terminal 08 of the drive module 102. A gate electrode 11 of the compensating thin film transistor 1082 is electrically connected with the second signal module 105, a source electrode 12 of the compensating thin film transistor 1082 is electrically connected with the first terminal 01 of the drive module 102, a drain electrode 13 of the compensating thin film transistor 1082 is electrically connected with the second control terminal 08 of the drive module 102, and the drain electrode 13 of the compensating thin film transistor 1082 is configured to adjust the threshold voltage of the drive module 102. Specifically, referring to FIG. 2, when the second signal module 105 outputs a high voltage, the compensating thin film transistor 1082 can be turned on, so that the drain electrode and the top gate electrode of the driving thin film transistor 1021 are connected, the potential of the drain electrode and bottom gate electrode of the driving thin film transistor 1021 drops until the driving thin film transistor 1021 turns off. At this time, the compensation capacitor 1081 obtains the threshold voltage of the driving thin film transistor 1021.

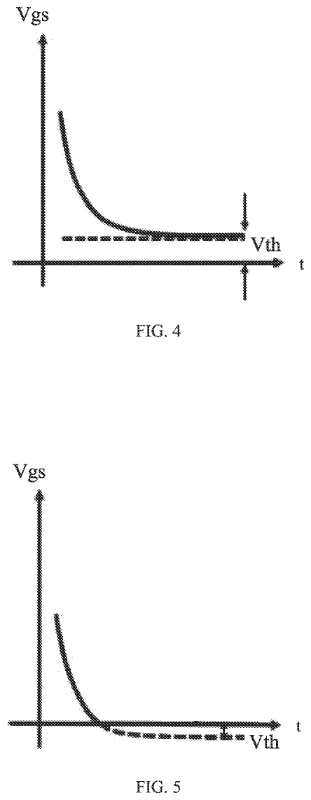

Referring to FIG. 3, it should be noted that when the driving thin film transistor 1021 is a transistor with an N-type vertical single-gate structure, a source electrode of the compensating thin film transistor 1082 is electrically connected with the drain electrode of the transistor with the N-type vertical single-gate structure, and a drain electrode of the compensating thin film transistor 1082 is electrically connected with the gate electrode of the transistor with the N-type vertical single-gate structure. When the gate electrode of the transistor with the N-type vertical single-gate structure is loaded with a high voltage, the transistor with the N-type vertical single-gate structure is formed a diode structure. Referring to FIG. 4, assuming that the threshold voltage of the transistor with the N-type vertical single-gate structure is Vth, and the voltage difference between the gate and the source electrode of the transistor with the N-type vertical single-gate structure is Vgs, when Vth>0V, the voltage of the gate electrode of the transistor with the N-type vertical single-gate structure will be released through the diode structure until when Vgs=Vth, the diode structure is turned off. At this time, the Vth can be detected from the gate electrode of the transistor with the N-type vertical single-gate structure, and the Vth can be further compensated. Referring to FIG. 5, when Vth<0V, the transistor with the N-type vertical single-gate structure is always on, then Vgs=0V, and the Vth cannot be detected from the gate electrode of the transistor with the N-type vertical single-gate structure. Therefore, Vth cannot be compensated.

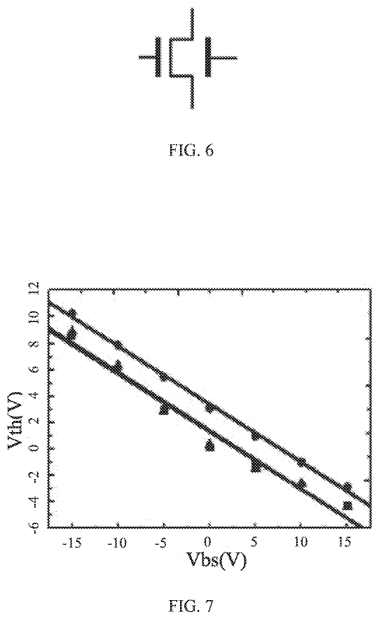

Furthermore, referring to FIG. 6, when the driving thin film transistor 1021 is an N-type vertical double-gate structure transistor, it is assumed that the threshold voltage of the N-type vertical double-gate structure transistor is Vth. The voltage difference between the bottom gate and the source electrode of the N-type vertical double-gate structure transistor is Vbs. Referring to FIG. 6, it is a function image of the

Vth and the Vbs of two different types of N-type vertical double-gate transistors. It can be seen from FIG. 7 that for different types of N-type vertical double-gate transistors, the Vth and the Vbs are in a linear relationship, namely, the Vbs of each N-type vertical double-gate transistor can linearly and dynamically adjust Vth. Therefore, in this embodiment, the driving thin film transistor 1021 is set as an N-type vertical double gate structure transistor. Vth is adjusted to be a positive value by changing the voltage of the bottom gate electrode of the transistor of the N-type vertical double gate structure, and Vth is detected.

In one embodiment of the present disclosure, referring to FIG. 1, the pixel circuit 100 further includes a data signal module 109, a write module 201 and a memory module 202. An input terminal 14 of the write module 201 is electrically connected with the data signal module 109. A first terminal 15 of the memory module 202 is electrically connected with an output terminal 16 of the memory module 202 and the first control terminal 02 of the drive module 102, and a second terminal 17 of the memory module 202 is electrically connected with the second terminal 22 of the drive module 102. In one embodiment of the present disclosure, referring to FIG. 2, the writing module 201 may include a writing switch 2011. A first terminal of the write switch 2011 is set as the input terminal 14 of the write module 201, and a second terminal of the write switch 2011 is set as the output terminal 16 of the write module 201. A control terminal 20 of the write switch 2011 can be electrically connected with a scanning voltage module 203. The scan voltage module 203 is used to control whether the write switch 2011 is turned on. The storage module 202 includes a storage capacitor 2021. A first terminal of the storage capacitor 2021 is set as the first terminal 15 of the storage module 202, and the second terminal of the storage capacitor 2021 is set as the second terminal 17 of the storage module 202. The storage capacitor 2021 is used to store the data signal. Specifically, when the scan voltage module 203 controls the write switch 2011 to turn on, the data signal module 109 writes the data signal to the storage capacitor 2021 and the driving thin film transistor 1021 by the write switch 2011.

In one embodiment of the present disclosure, referring to FIG. 1, the pixel circuit 100 further includes a pre-storage module 204. An input terminal 18 of the pre-storage module 204 is electrically connected with the output terminal 16 of the write module 201, and an output terminal 19 of the pre-storage module 204 is electrically connected with the first terminal 15 of the memory module 202. The pre-storage module 204 is configured to store the data signal provided by the data signal module 109. It can be understood that the pre-storage module 204 electrically connects the writing module 201 and the storage module 202. The pre-storage module 204 may buffer the data signal to write the data signal to the storage module 202 at an appropriate time.

In one embodiment of the present disclosure, referring to FIG. 2, the pre-storage module 204 includes a pre-storage capacitor 2041 and a pre-storage switch 2042. A first terminal of the pre-storage capacitor 2041 is set as the input terminal 18 of the pre-storage module 204, and a second terminal of the pre-storage capacitor 2041 is connected with the ground terminal. The pre-storage capacitor 2041 is configured to store the data signal. A first terminal of the pre-storage switch 2042 is electrically connected with the first terminal of the pre-storage capacitor 2041, a second terminal of the pre-storage switch 2042 is set as the output terminal 19 of the pre-storage module 204. The pre-storage switch 2042 is configured to control whether the first control terminal 02 of the drive module 102 is loaded with the data signal.

The embodiments of the present disclosure provide a driving method, which is applied to any of the above-mentioned pixel circuits, and the driving method includes, but is not limited to, the following embodiments and a combination of the following embodiments.

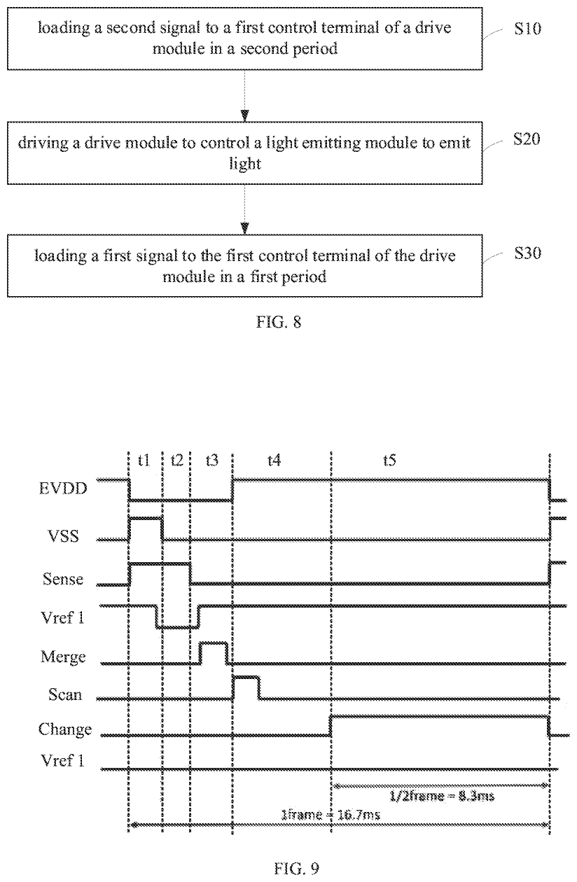

In one embodiment of the present disclosure, referring to FIG. 8, The driving method includes but is not limited to the following steps.

S10, loading a second signal to a first control terminal of a drive module in a second period.

In one embodiment of the present disclosure, referring to FIG. 1, the pixel circuit 100 further includes a second signal module 105. The second signal module 105 is electrically connected with the first control terminal 02 of the drive module 102, and the first control terminal 02 of the drive module 102 is loaded with a second signal by the second signal module 105 in the second period, and a polarity of the second signal is positive.

In one embodiment of the present disclosure, referring to FIG. 2, the second signal module 105 includes a second signal source 1051 and a second switch 1052, the second switch 1052 is turned on in the second period for driving the second signal source 1051 to load the second signal to the first control terminal 02 of the drive module 102. Specifically, as shown in FIG. 1, a control terminal 06 of the second switch 1052 is electrically connected with a second control signal module 107. The second control signal module 107 can output a periodic second pulse signal, and a pulse width of the second pulse signal is equal to the second time period. The second signal source 1051 outputs a second signal, and the second signal may specifically be a constant voltage signal with a positive polarity. When the control terminal 06 of the second switch 1052 is loaded with a second signal, and the second signal is in the high voltage period of the second pulse signal, the second switch 1052 is turned on, and the second signal is loaded on the first control terminal 02 of the drive module 102 through the second switch 1052.

S20, driving a drive module to control a light emitting module to emit light.

Referring to FIG. 1, the pixel circuit 100 further includes a power module 103, a power supply terminal 03 of the light emitting module 101 is electrically connected with the power module 103, and a working terminal 04 of the light emitting module 101 is electrically connected with the first terminal 01 of the drive module 102. When an operating voltage output by the power module 103 is constant, the drive module 102 can control the light emitting condition of the light emitting module 101. Specifically, referring to FIG. 2, the light emitting module 101 includes a micro light emitting diode 1011. An anode terminal of the micro light emitting diode 1011 is set as the power supply terminal 03 of the light emitting module 101, and a cathode terminal of the micro light emitting diode 1011 is set as the working terminal 04 of the light emitting module 101. The signal output by the power module 103 may be a constant high voltage signal, and the constant high voltage signal is greater than the voltage of the first terminal 01 of the drive module 102, so that the micro light emitting diode 1011 emits light.

S30, loading a first signal to the first control terminal of the drive module in a first period.

In one embodiment of the present disclosure, referring to FIG. 1, the pixel circuit 100 further includes a first signal module 104. The first signal module 104 is electrically connected with the first control terminal of the drive module 102, and the first control terminal 02 of the drive module 102 is loaded with a first signal by the first signal module 104 in the first period, and a polarity of the first signal is negative.

In one embodiment of the present disclosure, referring to FIG. 2, the first signal module 104 includes a first signal source 1041 and a first switch 1042, the first switch 1042 is turned on in the first period for driving the first signal source 1041 to load the first signal to the first control terminal 02 of the drive module 102. Specifically, a control terminal 05 of the first switch 1042 is electrically connected with a first control signal module 106. The first control signal module 106 can output a periodic first pulse signal, and a pulse width of the first pulse signal is equal to the first time period. The first signal source 1041 outputs a first signal, and the first signal may specifically be a constant voltage signal with a negative polarity. When the control terminal 05 of the first switch 1042 is loaded with a first signal, and the first signal is in the high voltage period of the first pulse signal, the first switch 1042 is turned on, and the first signal is loaded on the first control terminal 02 of the drive module 102 through the first switch 1042.

Since the first control terminal 02 of the drive module 102 is loaded with a first signal by the first signal with a negative polarity module 104 in the first period, the first control terminal 02 of the drive module 102 is loaded with a second signal with a positive polarity by the second signal module 105 in the second period, and one cycle of working time of the drive module 102 may include the first period and the second period, the first control terminal 02 of the drive module 102 can be alternately loaded with two voltages with different polarities during the working time of the drive module 102, and the deviation of the threshold voltage of the drive module 102 can be slowed down to stabilize the driving current of the light emitting module 101, so as to improve the display uniformity of the display panel and reduce the lifespan of the display panel.

In one embodiment of the present disclosure, FIG. 9 is a timing diagram corresponding to the circuit diagram shown in FIG. 2. Specifically, EVDD is an electrical signal output by the power module 103. VSS is a signal loaded on the second terminal of the storage capacitor and the source electrode of the driving thin film transistor. Sense is a signal loaded on the control terminal 05 of the first switch 1042. Vref 1 is a signal output by the first signal source 1041. Merge is a signal output by the pre-stored voltage module 205. Scan may be a signal output by the scan voltage module 203, and Change is a signal loaded on the control terminal 06 of the second switch 1052. Vref 2 is a signal output by the second signal source 1051. Taking the first switch 1042 and the second switch 1052 as N-type thin film transistors as an example for description, the control terminal 05 of the first switch 1042 and the control terminal 06 of the second switch 1052 are respectively corresponding a gate electrode of an N-type thin film transistor.

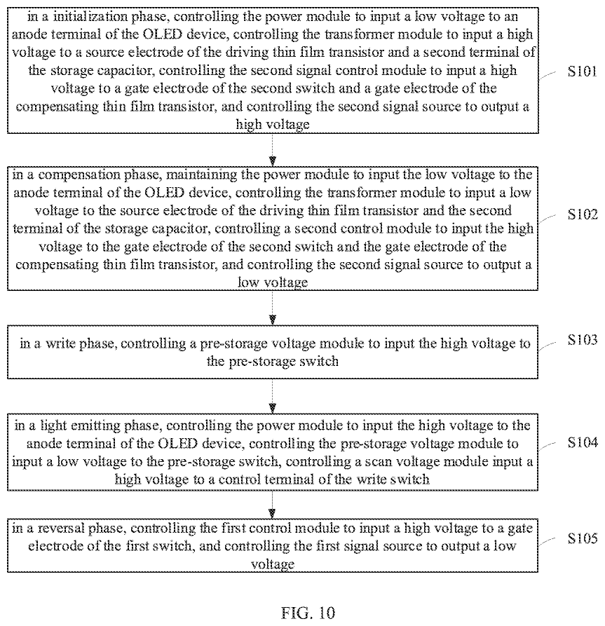

In one embodiment of the present disclosure, according to a timing diagram shown in FIG. 9 and a circuit diagram shown in FIG. 2, the driving method includes a plurality of steps shown in FIG. 10.

S101, in a initialization phase, controlling the power module to input a low voltage to an anode terminal of the OLED device, controlling the transformer module to input a high voltage to a source electrode of the driving thin film transistor and a second terminal of the storage capacitor, controlling the second signal control module to input a high voltage to a gate electrode of the second switch and a gate electrode of the compensating thin film transistor, and controlling the second signal source to output a high voltage.

Referring to FIG. 2 and FIG. 9, in the initialization phase t1, the Sense is at a high voltage, namely, the second control signal module 107 outputs a high voltage, and the second switch 1052 is turned on. The Vref 1 is a high voltage, namely, the second signal source 1051 outputs a high voltage, and the driving thin film transistor 1021 is turned on. The EVDD output by the power module 103 is a low voltage, and the VSS of a transformer module 206 is a high voltage, namely, the anode terminal voltage of the micro light emitting diode 1011 is lower than the cathode terminal voltage of the OLED device, namely, the micro light emitting diode 1011 is not on-state, so that the micro light emitting diode 1011 is in a black-out state. Simultaneously, referring to FIG. 2, a gate 11 of the compensating thin film transistor 1082 is also electrically connected with the second control signal module 107, namely, the compensating thin film transistor 1082 is also turned on, namely, the bottom gate electrode and drain electrode of the driving thin film transistor 1021 are turned on, the VSS is transmitted to the bottom gate electrode of the driving thin film transistor 1021 and the first terminal 10 of the compensation capacitor 1081 through the driving thin film transistor 1021 and the compensating thin film transistor 1082, so that a voltage of the bottom gate electrode of the driving thin film transistor 1021 is increased, and the threshold voltage of the driving thin film transistor 1021 is further adjusted to a negative value.

S102, in a compensation phase, maintaining the power module to input the low voltage to the anode terminal of the OLED device, controlling the transformer module to input a low voltage to the source electrode of the driving thin film transistor and the second terminal of the storage capacitor, controlling a second control module to input the high voltage to the gate electrode of the second switch and the gate electrode of the compensating thin film transistor, and controlling the second signal source to output a low voltage.

Referring to FIG. 2 and FIG. 9, in the compensation phase t2, since the Sense is a high voltage, the same as the initialization phase t1, the second switch 1052 is turned on. The Vref 1 is a low voltage, combined with the threshold voltage of the driving thin film transistor 1021 being a negative value, at this time, the voltage of the top gate electrode of the driving thin film transistor 1021 is still higher than the threshold voltage of the driving thin film transistor 1021, namely the driving thin film transistor 1021 is still turned on. The EVDD is a low voltage, and the VSS is a low voltage. The same as the initialization phase t1, the micro light emitting diode 1011 is in the off state. Simultaneously, the voltage of the bottom gate electrode of the driving thin film transistor 1021 is sequentially discharged to the transformer module 206 through the compensating thin film transistor 1082 and the driving thin film transistor 1021, so that the voltage of the bottom gate electrode of the driving thin film transistor 1021 is reduced , the threshold voltage of the driving thin film transistor 1021 rises until the threshold voltage of the driving thin film transistor 1021 is equal to the voltage of the top gate electrode of the driving thin film transistor 1021, namely, the voltage of the Vref 1 at this time, the driving thin film transistor 1021 is off. The compensation capacitor 1081 stores the voltage of the bottom gate electrode of the driving thin film transistor 1021.

S103, in a write phase, controlling a pre-storage voltage module to input the high voltage to the pre-storage switch.

Referring to FIG. 2 and FIG. 9, in the write phase t3, the Merge is a high voltage. At this time, the data signal pre-stored in the pre-storage capacitor 2041 in the previous frame can be written into the storage capacitor 2021 through the pre-storage switch 2042.

S104, in a light emitting phase, controlling the power module to input the high voltage to the anode terminal of the OLED device, controlling the pre-storage voltage module to input a low voltage to the pre-storage switch, controlling a scan voltage module input a high voltage to a control terminal of the write switch.

Referring to FIG. 2 and FIG. 9, in the light emitting phase t4, a voltage at the anode terminal of the micro light emitting diode 1011 is a high voltage, so the micro light emitting diode 1011 emits light, a current flowing through the micro light emitting diode 1011 is

$$I = \frac{1}{2} μ {C}_{ox} \frac{W}{L} {( {αV}_{data} - {V}_{ref} )}^{2} ,$$

μ is a carrier mobility of driving thin film transistor 1021. Cox is a capacitance per unit area. The (W/L) is the aspect ratio of the driving thin film transistor 1021. The α is the transmission efficiency of the data signal to the gate electrode of the driving thin film transistor 1021. The Vdata is a voltage value of the data signal. The Vref is the voltage value at which the signal output by the first signal source 1041 is at a high voltage. Simultaneously, the write switch 2011 is turned on, and the data signal module 109 of this frame is pre-stored in the pre-storage capacitor 2041 through the write switch 2011.

S105, in a reversal phase, controlling the first control module to input a high voltage to a gate electrode of the first switch, and controlling the first signal source to output a low voltage.

Referring to FIG. 2 and FIG. 9, in the reversal phase t5, since the Change is a high voltage, namely, the first control signal module 106 outputs a high voltage, and the first switch 1042 is turned on. The Vref 2 is a low voltage, namely, the first signal source 1041 outputs a low voltage, and a voltage difference between the gate electrode and the source electrode of the driving thin film transistor 1021 is a negative value, which is the opposite of the previous one. Specifically, the reversal phase t5 may occupy half of the period of one frame, for example, the period of one frame is 16.7 milliseconds, namely, the sum of t1 to t5 is 16.7 milliseconds, and the reversal phase t5 may be 8.3 milliseconds. Further, the inversion stage can also be understood as performing black insertion processing on the pixel unit corresponding to the pixel circuit 100, namely, this embodiment can also implement the black insertion processing on the pixel unit corresponding to the pixel circuit 100 to Reduce smear phenomenon.

It should be noted that when SiNx:H is used to make the active layer of the driving thin film transistor 1021, the positive deflection stress mainly causes the increase of the De state density in a-Si:H, and the negative deflection stress mainly causes the decrease of the De state density. When SiO2 is used to make the active layer of the driving thin film transistor 1021, the threshold voltage drift is caused by the generation of De state in a-Si:H under positive bias and the generation of Dh state under negative bias. When a (SiNx:H)/SiO2 composite layer is used to make the active layer of the driving thin film transistor 1021, the drift of the threshold voltage is caused by the increase of the De state in a-Si: H and the decrease of the Dh state under the positive bias and the decrease of the De state while the increase of the Dh state under the negative bias.

It is understood that by alternately inputting two voltage signals with opposite polarity to the gate electrode of the driving thin film transistor 1021, this embodiment makes the voltage difference between the gate electrode and the source electrode of the driving thin film transistor 1021 alternately present a positive value and a negative value. According to above analysis, this embodiment can make the generation of the a-Si:H intermediate state a dynamic equilibrium process, namely, the positive bias stress mainly causes the density of De states in the active layer amorphous silicon of the driving thin film transistor 1021 to increase and the density of Dh states to decrease. The negative deviator stress mainly causes the decrease of the density of De states and the increase of the density of Dh states, and the positive deviator stress and the negative deviator stress alternately. Therefore, the drift of the threshold voltage of the driving thin film transistor 1021 maintains a dynamic balance to achieve the stability of the output current.

An embodiment of the present disclosure also provides a display panel, the display panel includes any one of the pixel circuit in the above embodiments.

An embodiment of the present disclosure also provides a display device, the display device includes the display panel in the above embodiments.

The present disclosure provides a pixel circuit and its driving method, a display panel, and a display device. The pixel circuit includes a light emitting module and a drive module. A first terminal of the drive module is electrically connected with the light emitting module. A first control terminal of the drive module is configured to load a first signal in a first period, and the first control terminal of the drive module is configured to load a second signal in a second period, the first signal and the second signal have opposite polarity, and there is no intersection between the first period and the second period. It is realized that the first control terminal of the drive module is alternately loaded as the first signal and the second signal with opposite polarity in the first period and the second period. Therefore, in the present disclosure, the first control terminal of the drive module is alternately set to two signals with opposite polarity, so as to slow down the deviation of the threshold voltage of the drive module and stabilize the driving current of the light-emitting module, and to improve the display uniformity of the display panel and reduce the life of the display panel.

1. A pixel circuit, comprising:
a light emitting module;
a drive module, a first terminal of the drive module is electrically connected with the light emitting module, a first control terminal of the drive module is configured to load a first signal in a first period, and the first control terminal of the drive module is configured to load a second signal in a second period, the first signal and the second signal have opposite polarity, and there is no intersection between the first period and the second period.

2. The pixel circuit of claim 1, wherein the pixel circuit further comprises:
a first signal module, the first signal module is electrically connected with the first control terminal of the drive module, and the first control terminal of the drive module is loaded with a first signal by the first signal module in the first period, and a polarity of the first signal is negative; and
a second signal module, the second signal module is electrically connected with the first control terminal of the drive module, and the first control terminal of the drive module is loaded with a second signal by the second signal module in the second period, and a polarity of the second signal is positive.

3. The pixel circuit of claim 2, wherein the first signal module comprises a first signal source and a first switch, the first switch is turned on in the first period for driving the first signal source to load the first signal to the first control terminal of the drive module.

4. The pixel circuit of claim 2, wherein the second signal module comprises a second signal source and a second switch, the second switch is turned on in the second period for driving the second signal source to load the second signal to the first control terminal of the drive module.

5. The pixel circuit of claim 1, wherein the drive module comprises a driving thin film transistor which is a double gate thin film transistor, a top gate electrode of the driving thin film transistor is set as the first control terminal of the drive module, and a bottom gate electrode of the driving thin film transistor is set as a second control terminal of the drive module.

6. The pixel circuit of claim 5, wherein when the driving thin film transistor is an N-type thin film transistor, a threshold voltage of the driving thin film transistor is positively correlated with the top gate electrode of the driving thin film transistor, and the threshold voltage of the driving thin film transistor is negatively correlated with the bottom gate electrode of the driving thin film transistor.

7. The pixel circuit of claim 5, wherein the pixel circuit further comprises:
a compensation module configured to adjust a threshold voltage of the drive module, a first terminal of the compensation module is electrically connected with the second control terminal of the drive module, and a second terminal of the compensation module is electrically connected with the first terminal of the drive module.

8. The pixel circuit of claim 7, wherein the compensation module comprises:
a compensation capacitor configured to store a signal of the second control terminal of the drive module, a first terminal of the compensation capacitor is electrically connected with the second control terminal of the drive module, and a second terminal of the compensation capacitor is connected with a ground terminal; and
a compensating thin film transistor, a gate electrode of the compensating thin film transistor is electrically connected with the second signal module, a source electrode of the compensating thin film transistor is electrically connected with the first terminal of the drive module, a drain electrode of the compensating thin film transistor is electrically connected with the second control terminal of the drive module, and the drain electrode of the compensating thin film transistor is configured to adjust the threshold voltage of the drive module.

9. The pixel circuit of claim 1, wherein the pixel circuit further comprises:
a data signal module;
a write module, an input terminal of the write module is electrically connected with the data signal module; and
a memory module, a first terminal of the memory module is electrically connected with an output terminal of the memory module and the first control terminal of the drive module, and a second terminal of the memory module is electrically connected with the second terminal of the drive module.

10. The pixel circuit of claim 9, wherein the write module comprises a write switch, a first terminal of the write switch is set as the input terminal of the write module, a second terminal of the write switch is set as the output terminal of the write module, and a control terminal of the write switch is electrically connected with a scanning voltage module configured to control whether the write switch is turned on; and
the memory module comprises a storage capacitor configured to store a data signal, a first terminal of the storage capacitor is set as the first terminal of the memory module, and a second terminal of the storage capacitor is set as the second terminal of the memory module.

11. The pixel circuit of claim 8, wherein the pixel circuit further comprises a pre-storage module configured to store the data signal provided by the data signal module, an input terminal of the pre-storage module is electrically connected with the output terminal of the write module, and an output terminal of the pre-storage module is electrically connected with the first terminal of the memory module.

12. The pixel circuit of claim 10, wherein the pre-storage module comprises:
a pre-storage capacitor configured to store the data signal, a first terminal of the pre-storage capacitor is set as the input terminal of the pre-storage module, and a second terminal of the pre-storage capacitor is connected with the ground terminal; and
a pre-storage switch configured to control whether the first control terminal of the drive module is loaded with the data signal, a first terminal of the pre-storage switch is electrically connected with the first terminal of the pre-storage capacitor, a second terminal of the pre-storage switch is set as the output terminal of the pre-storage module.

13. The pixel circuit of claim 1, wherein the light emitting module includes a micro light emitting diode.

14. The pixel circuit of claim 1, wherein the pixel circuit further comprises a power module, a power supply terminal of the light emitting module is electrically connected with the power module, and a working terminal of the light emitting module is electrically connected with the first terminal of the drive module, a light emitting condition of the light emitting module is controlled by the driving module, a driving current of the light emitting module is adjusted by the drive module.

15. A display panel, wherein the display panel comprises the pixel circuit of claim 1.

16. A display device, wherein the display device comprises the display panel of claim 15.

17. A driving method, wherein the driving method is applied to the pixel circuit of claim 1, and the driving method comprises:
loading a second signal to a first control terminal of a drive module in a second period;
driving a drive module to control a light emitting module to emit light; and
loading a first signal to the first control terminal of the drive module in a first period.

18. The driving method of claim 17, wherein the pixel circuit further comprises a power module, a transformer module, a memory module, a first signal module, a second signal module, a compensation module, a pre-storage module and a write module, the light emitting module comprises a OLED device, the drive module comprises a driving thin film transistor, the memory module comprises a storage capacitor, the first signal module comprises a first signal source and a first switch, the second signal module comprises a second signal source and a second switch, the compensation module comprises a compensating thin film transistor, the pre-storage module comprises a pre-storage switch, the write module comprises a write switch, and the driving method further comprises:
in a initialization phase, controlling the power module to input a low voltage to an anode terminal of the OLED device, controlling the transformer module to input a high voltage to a source electrode of the driving thin film transistor and a second terminal of the storage capacitor, controlling the second signal control module to input a high voltage to a gate electrode of the second switch and a gate electrode of the compensating thin film transistor, and controlling the second signal source to output a high voltage;
in a compensation phase, maintaining the power module to input the low voltage to the anode terminal of the OLED device, controlling the transformer module to input a low voltage to the source electrode of the driving thin film transistor and the second terminal of the storage capacitor, controlling a second control module to input the high voltage to the gate electrode of the second switch and the gate electrode of the compensating thin film transistor, and controlling the second signal source to output a low voltage;
in a write phase, controlling a pre-storage voltage module to input the high voltage to the pre-storage switch;
in a light emitting phase, controlling the power module to input the high voltage to the anode terminal of the OLED device, controlling the pre-storage voltage module to input a low voltage to the pre-storage switch, controlling a scan voltage module input a high voltage to a control terminal of the write switch; and
in a reversal phase, controlling the first control module to input a high voltage to a gate electrode of the first switch, and controlling the first signal source to output a low voltage.
